(19) United States
(12) Patent Application Publication
(10) Pub. No.: US 2012/0187769 A1
(43) Pub. Date: Jul. 26, 2012

(54) Energy Supply System

(76) Inventors: Stefan Spannhake, Markgroeningen (DE); Jochen Fassnacht, Calw (DE); Jochen Heusel, Reutlingen (DE)

(21) Appl. No.: 13/384,908

(22) PCT Filed: Jun. 8, 2010
(86) PCT No.: PCT/EP2010/057997

§ 371 Date: Apr. 5, 2012

(30) Foreign Application Priority Data
Jul. 24, 2009 (DE) 10 2009 027 991.1

(51) Int. Cl. H02J 1/00

(52) U.S. Cl. 307/82

(57) ABSTRACT

An energy supply system has a number of DC choppers for converting the input voltages applied in each case into output voltages, and a number of energy storages for providing the input voltages, an energy storage being assigned to each DC chopper. An output voltage of at least one of the number of DC choppers is settable as a function of a setpoint input in order to expose the energy storage assigned to the at least one DC chopper to a load individually.

### BACKGROUND OF THE INVENTION

1. Field of the Invention

The present invention relates to energy supply using energy storages, e.g., using electric vehicle or hybrid vehicle batteries.

2. Description of Related Art

Known electric vehicle or hybrid vehicle batteries are made up of individual battery cells, which always have certain individual variations, for example, with respect to efficiency. Furthermore, the battery cells are often thermally coupled to the environment in different ways, so that they can also heat up inconsistently. To achieve a uniform load of the battery cells, they are usually connected in series so that the same current flows through each battery cell. However, the cells are not exposed to loads as a function of their particular load capacity, which can result in reduced efficiency of the overall system.

### BRIEF SUMMARY OF THE INVENTION

The present invention is based on the finding that the efficiency of a system having a plurality of series-connected energy storages may be improved if the energy storages, for example, batteries or battery cells, are exposed to loads individually, for example, consistent with the particular age condition or other boundary conditions. To this end, each energy storage, which may be made up of one or multiple energy storage modules or energy storage cells, may be provided with an equipotential bonding DC chopper, also referred to as a DC/DC converter (DC: direct current). If the DC choppers are connected in series, for example, on the output side, each energy storage may be exposed to a load by specifically activating each DC chopper in conformity with the energy storage's present load capacity and thus operated optimally. Thus, the energy storages are not operated directly, but instead indirectly through one or multiple DC choppers which convert the voltage of the energy storages into, for example, a selectable output voltage as a step-up converter or a step-down converter.

The present invention relates to a power supply system having a number of DC choppers for converting an input voltage applied in each case into an output voltage, and the number of energy storages, it being possible for each energy storage to be assigned to a DC chopper. Preferably, an output voltage of at least one DC chopper of the number of DC choppers is settable as a function of a setpoint input. The energy storages may be, for example, each made up of one or multiple energy storage cells, the output voltage output by the particular energy storage being fed to the particular DC chopper as an input voltage. The setting of the output voltage of a DC chopper makes it possible to expose the energy storage assigned to this DC chopper to a load individually.

According to one specific embodiment, the output voltages of a plurality or the number of DC choppers are each settable according to a setpoint input, in order to expose the energy storages to a load individually, in particular differently, under the same current load of the DC choppers. This produces an advantageous distribution of the loads to individual energy storages.

According to one specific embodiment, the DC choppers are connectible or connected in series, which advantageously makes it possible for each energy storage to be exposed to a load individually and voltage-dependently.

According to one specific embodiment, the DC choppers are distinguished by identical or different nominal outputs, making it possible to use energy storages of the same or different nominal outputs. In this case as well, it is advantageously possible to implement individual loading of the energy storages.

According to one specific embodiment, the setpoint input is DC chopper-specific and/or energy storage-specific, in particular energy storage output-specific. However, the setpoint input may be dependent on a sum of the output voltages of the number of DC choppers and/or on a setpoint output of the energy storage assigned to the at least one DC chopper and/or on a total output of all energy storages. This advantageously ensures that the setpoint input may be component-specific.

According to one specific embodiment, the output voltages of a plurality or the number of DC choppers are in each case settable as a function of a setpoint input or the above-mentioned setpoint input, in particular as a function of a DC chopper-specific setpoint input or an energy storage-specific setpoint input, in particular an energy storage output-specific setpoint input. This advantageously makes it possible for each energy storage to be exposed to a load individually.

According to one specific embodiment, the output voltage is settable only under the condition that the sum of the output voltages of the DC choppers, in particular a sum of all output voltages of all DC choppers which form a total intermediate circuit voltage, is constant. Voltage stability is thus achieved advantageously despite the individual exposure to loads of the energy storages.

According to one specific embodiment, output voltage U_{zkmodXsetpoint} of the at least one DC chopper is settable according to the formula

U_{zkmodXsetpoint}=U_{zk}*(P_{ModX}/Pₜₒₜₐₗ)

where U_{zk} denotes a sum of the output voltages of the number of DC choppers, Pₜₒₜₐₗ denotes a total output of the number of energy storages and P_{ModX} denotes a setpoint output of the energy storage or storages assigned to the at least one DC chopper. The efficiency of the nth DC chopper may be considered according to the direction of the energy flow.

This advantageously provides a simple rule for setting the output voltage of the DC chopper or the output voltages of the DC choppers.

According to one advantageous specific embodiment, the DC choppers are step-down converters or step-up converters, so that, for example, all DC choppers are step-down converters or step-up converters, or some of the DC choppers are step-down converters and the remaining DC choppers are step-up converters. This advantageously ensures great flexibility in generating the output voltages.

The present invention also relates to a method for supplying electrical energy using the energy supply system according to the present invention, whereby an output voltage of at least one DC chopper of the number of the DC choppers is set as a function of a setpoint input. According to one specific embodiment, the output voltages of a plurality or the number of DC choppers are in each case set as a function of a setpoint input, in particular as a function of a DC chopper-specific setpoint input or an energy storage-specific setpoint input. Advantageously, the setpoint input in each case considers exactly the condition of the particular energy storage, making it possible to set an individual load precisely.

The present invention further relates to the use of the energy supply system for supplying electrical energy in vehicles, in particular in electric vehicles.

### BRIEF DESCRIPTION OF THE DRAWINGS

FIG. 1 shows an energy supply system.

FIG. 2 shows another energy supply system.

### DETAILED DESCRIPTION OF THE INVENTION

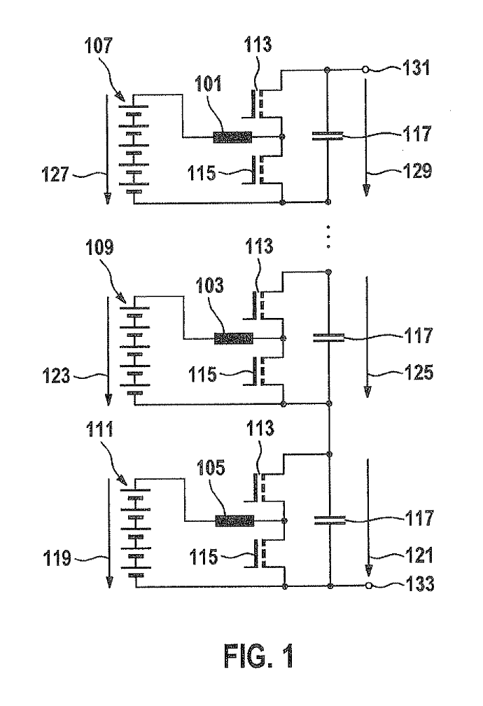

FIG. 1 shows an energy supply system having a number of DC choppers 101, 103 and 105. DC chopper 101 is connected downstream from an energy storage 107, DC chopper 103 is connected downstream from an energy storage 109 and DC chopper 105 is connected downstream from an energy storage 111. Each energy storage, for example, may be made up of one or multiple storage cells. The energy storages may be, for example, vehicle batteries.

On the output side, DC choppers 101, 103 and 105 are each connected to a circuit configuration including two transistors 113 and 115. On the output side, a smoothing capacitor 117 is provided optionally in each case.

DC choppers 101 through 105 shown in FIG. 1 are preferably connected in series, for example, input voltage 119, U_{mod1}, supplied to DC chopper 105 on the input side by energy storage 111, being converted into an output voltage 121, U_{zkmod1}. Accordingly, input voltage 123, U_{mod2}, which is supplied to the DC chopper on the input side by energy storage 109, is converted into output voltage 125, U_{zkmod2}. Accordingly, input voltage 127, U_{modx}, which is supplied to DC chopper 101 on the input side by energy storage 107, is converted into output voltage 129, U_{zkmodX}. In this connection, “X” denotes the number of DC choppers or the nth DC chopper in the energy supply system shown in FIG. 1. On the output side, the power supply system is provided with terminals 131 and 133, via which the sum of all voltages, i.e., the intermediate circuit voltage may be picked off. During operation, for example, intermediate circuit current I_{zk} flows into terminal 131. As is also shown in FIG. 1, DC choppers 101, 103 and 105 are connected directly to the particular energy storage 107, 109 and 111 on the input side. This makes it possible to use two-quadrant DC choppers.

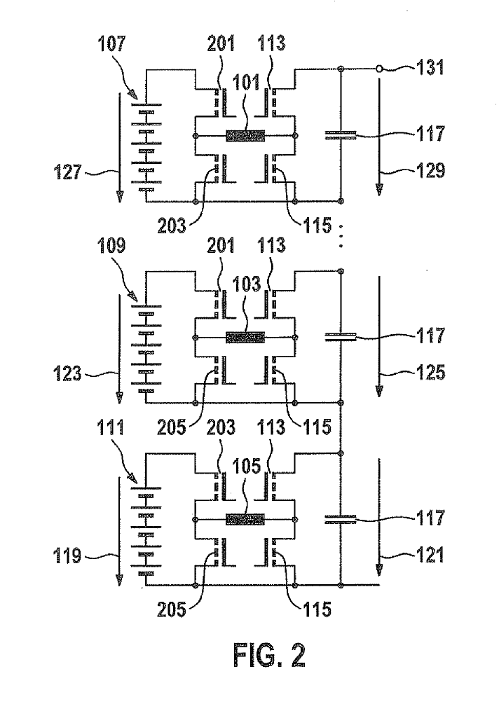

FIG. 2 shows an energy supply system, in which, in contrast to the energy supply system shown in FIG. 1, DC choppers 101, 103 and 105 may be designed as four-quadrant DC choppers, making it possible to eliminate a downward limitation of the particular output voltage. This advantageously makes it possible for the setpoint to be input without considering a lower limit. This is achieved by connecting each DC chopper 101, 103 and 105 on the input side via a further circuit configuration to two switching transistors 201 and 203 which are interconnected in the manner shown in FIG. 2.

As shown in FIGS. 1 and 2, the load of individual energy storages 107, 109 and 111 may be set individually, preferably via a change of output voltages U_{zkmod1 . . . X} of, for example, series-connected DC choppers 101, 103 and 105, although the same current flows through all DC choppers 101, 103 and 105.

If DC choppers 101, 103, 105 are, for example, two-quadrant DC choppers, it is advantageous, as shown in FIG. 1, for the particular output voltage U_{zkmod1 . . . X}, for example, to be higher or lower than is the particular output voltage of particular energy storage 107, 109, 111, i.e., U_{mod1 . . . X}. DC choppers 101, 103 and 105 may thus be designed as step-down converters or as step-up converters. This makes it possible to prevent a possibly uncontrollable current from flowing through an optionally used anti-parallel diode of upper transistor 113, which may be designed as a MOSFET or IGBT transistor. Since DC choppers 101 through 103 are connected directly to energy storages 107, 109, 111, this further ensures that the same number of DC choppers is always available. According to the energy supply system shown in FIG. 1, it is also achieved that each energy storage may be exposed to a load only within certain limits, which is determined by the lower voltage and accordingly power limitation. If, however, as shown in FIG. 2, DC choppers 101, 103 and 105 are designed as four-quadrant DC choppers, the above-mentioned limits are dropped. Furthermore, the DC choppers may be bridged or switched off.

If intermediate circuit current I_{ZK}, which flows during operation into, for example, terminal 131, is established, this causes this current to flow through all DC choppers 101, 103, 105 on the output side due to the series connection of the DC choppers. The minimum deliverable power P_{minX} of each energy storage is then

P_{minX}−I_{zk}*U_{modX-}

When more power is to be delivered, this is always made possible by increasing the particular output voltage of particular DC chopper 101, 103, 105, which is based on a power balancing of the particular DC chopper. It is preferably considered that the input power is similar in behavior to the output power. At a constant output current, it is therefore possible to vary the power by changing the particular output voltage of particular DC chopper 101, 103, 105. It is further possible to consider the efficiency of the particular DC chopper as well.

As described above, the output voltage of the particular DC chopper may be a function of a setpoint input. Such a setpoint input may consider, for example, specific powers of the total system, i.e., of the intermediate circuit, which must be recorded or delivered. On the other hand, the total voltage, i.e., the intermediate circuit voltage, may be kept constant as a sum of all output voltages of the DC choppers. In this case, the setpoint input for the output voltage of each DC chopper may require, for example, that the sum of all output voltages U_{zkmod1} . . . U_{zkmodx} of all DC choppers be equal to intermediate circuit voltage U_{zk} using U_{zk}=U_{zkmod1}+ . . . +U_{zkmodX}.

The distribution of the output voltages to the individual output voltages of the DC choppers may be established using the following formula

U_{zkmodXsetpoint}=U_{zk}*(P_{ModX}/Pₜₒₜₐₗ)

where Pₜₒₜₐₗ denotes the total power of all energy storages, i.e., the power requirement of the intermediate circuit, P_{ModX} denotes the setpoint power of the nth energy storage and U_{zkmodXsetpoint} denotes the output voltage of the nth DC chopper. The efficiency of the nth DC chopper may be considered according to the direction of the energy flow.

Furthermore, the setpoint power of the individual energy storages may be set proportional to or as a function of the load capacity of the energy storages. Accordingly, it may be established that the energy storage having the highest load capacity is able to absorb or deliver the greatest power, making it possible to establish the particular energy storage power as follows:

P_{ModX}=P_{ModXpos}/(P_{Mod1pos}+P_{Mod2pos}+ . . . +P_{ModXpos})*P_{Setpoint-}

where Pₛₑₜₚₒᵢₙₜ denotes an energy storage setpoint power, in particular a battery setpoint power, P_{ModXpos} denotes the allowable maximum power of the nth energy storage, it being optionally possible to consider the efficiency of the associated DC chopper. If, as explained above, the power is considered, a more precise tuning may be carried out in a further iteration step, which was omitted above for the sake of simplification.

If the allowable charge and discharge power of the energy storages are different, the setpoint voltage values, i.e., the output voltages of the energy storages, may be selected according to the particular current direction in the particular charge or discharge operation. The possible voltage ranges of the DC choppers, in particular the lower voltage limit when two-quadrant DC choppers are used, may preferably also be considered when inputting the setpoint. If it is not possible to reduce the output voltage of the particular energy storage or of the particular DC chopper as required, it is possible, for example, to limit the total power delivery.

The DC choppers are preferably equipped with a voltage regulation, which adjusts the predefined output voltage to U_{zkmod1setpoint . . . zkmodXsetpoint} according to the particular setpoint input. Preferably it is also possible to consider the efficiency of the particular DC chopper, in particular in the case of power balancing, in which a relationship between the output power and the input power is determined, in particular if the particular DC chopper operates in an extreme partial load range, in which, for example, less than 10% of the maximum available load may be requested.

The control of the DC choppers may be performed, for example, by a master control device, for example, a software device. The software device may be, for example, provided for running control software for controlling the DC choppers, which, for example, may be used within a battery management.

1-12. (canceled)

13. An energy supply system, comprising:
a plurality of DC choppers each converting an applied input voltage into an output voltage; and
a plurality of energy storages for providing the input voltages to the DC choppers, wherein each energy storage is assigned to a corresponding single DC chopper;
wherein an output voltage of at least one of the plurality of DC choppers is set as a function of a setpoint input in order to expose the at least one energy storage assigned to the at least one DC chopper to a load individually.

14. The energy supply system as recited in claim 13, wherein the output voltages of the plurality of DC choppers are each set according to an assigned setpoint input in order to expose the energy storages to a load individually under the same current load of the DC choppers.

15. The energy supply system as recited in claim 13, wherein the DC choppers are connected in series.

16. The energy supply system as recited in claim 14, wherein the DC choppers have different nominal outputs.

17. The energy supply system as recited in claim 14, wherein the output voltages of the plurality of DC choppers are each set according to one of a DC-chopper-specific setpoint input or an energy-storage-specific setpoint input.

18. The energy supply system as recited in claim 14, wherein the output voltages of the plurality of DC chopper are set under the condition that a sum of the output voltages of all of the DC choppers is constant.

19. The energy supply system as recited in claim 14, wherein the setpoint input is one of:
(i) DC-chopper-specific;
(ii) energy-storage-specific; or
(iii) dependent on at least one of (1) a sum of the output voltages of the plurality of DC choppers, (2) a setpoint output of the energy storage assigned to the at least one DC chopper, (3) a total output of the plurality of energy storages, and (4) a ratio between the setpoint output of the energy storage assigned to the at least one DC chopper and the total output of the plurality of energy storages.

20. The energy supply system as recited in claim 14, wherein the output voltage U_{zkmodXsetpoint} of the at least one DC chopper is set according to the relationship
U_{zkmodXsetpoint}=U_{zk}*(P_{ModX}/Pₜₒₜₐₗ)
where U_{zk} denotes a sum of the output voltages of the plurality of DC choppers, Pₜₒₜₐₗ denotes a total output of the plurality of energy storages, and _{PModX} denotes a setpoint output of the energy storage assigned to the at least one DC chopper.

21. The energy supply system as recited in claim 14, wherein the DC choppers are one of step-down converters or step-up converters.

22. A method for supplying electrical energy, comprising:
providing an energy supply system including a plurality of DC choppers each converting an applied input voltage into an output voltage, and a plurality of energy storages for providing the input voltages to the DC choppers, wherein each energy storage is assigned to a corresponding single DC chopper; and
setting an output voltage of at least one of the plurality of DC choppers as a function of a setpoint input in order to expose the at least one energy storage assigned to the at least one DC chopper to a load individually.

23. The method as recited in claim 22, wherein the output voltages of the plurality of DC choppers are each set according to one of a DC-chopper-specific setpoint input or an energy-storage-specific setpoint input.

24. The method as recited in claim 23, wherein the electrical energy is supplied in one of electric vehicles or hybrid vehicles.
